(19) United States
(12) Patent Application Publication
(10) Pub. No.: US 2012/0068858 A1
(43) Pub. Date: Mar. 22, 2012

(54) TRAFFIC NEGOTIATION SYSTEM

(76) Inventor: Edward Fredkin, Brookline, MA (US)

(21) Appl. No.: 13/240,282

(22) Filed: Sep. 22, 2011

Related U.S. Application Data
(60) Provisional application No. 61/385,396, filed on Sep. 22, 2010.

(51) Int. Cl. G08G 1/0967

(52) U.S. Cl. 340/902

(57) ABSTRACT

A method for managing flow of vehicular traffic includes advising drivers of directed vehicles to form a first pack of directed vehicles that has a lead vehicle and at least one trailing vehicle, advising each of the drivers of trailing vehicles in the first pack to maintain a selected inter-vehicle gap; receiving, from a driver of a first vehicle, information concerning an intended destination of the driver; and at least in part on the basis of the information, advising the driver of the first vehicle to join the first pack.

### CROSS REFERENCE TO RELATED APPLICATIONS

This application claims the priority of U.S Provisional Application No. 61/385,396 filed on Sep. 22, 2010, the contents of which are hereby incorporated by reference in their entirety.

### FIELD OF DISCLOSURE

The disclosure relates to traffic engineering, instrumentation and control, and in particular, to greatly increasing traffic safety, flow or capacity on existing roads, bridges and tunnels while also decreasing travel times, especially during periods of high traffic.

### BACKGROUND

Traffic flow, particularly but not exclusively in and around large cities, is often hampered by inability of the roadway infrastructure (roads, bridges, tunnels, intersections, traffic signals, speed limits, traffic police, etc.) to allow or enable all vehicles to expeditiously get to their destinations, especially during times of greater than average traffic or under unusual conditions involving construction, accidents, weather, special events, etc. When a road, bridge or tunnel is unable to expeditiously handle the amount of traffic, one response is to construct additional capacity (widen roads to include more lanes, build limited access roads, build new bridges or tunnels, etc.). Another response is to artificially restrict the traffic, for example by restricting entry into downtown areas based on the last digit of the vehicle license plate; as is done in the city of Manila in the Philippines. Enormous traffic jams sometimes occur as an unnecessary consequence of accidents, construction, weather, or other conditions or circumstances.

### SUMMARY

In one aspect, the invention features a system for managing traffic by providing information to a driver of a first road vehicle. Such a system includes a first director adapted for mounting in the first road vehicle. The first director includes a user interface for communicating the advice to the driver and for receiving information from the driver, the information being indicative of driver intent; a communication system for establishing communication with other directors in other road vehicles; a positioning system for establishing a location of the first director; and a processor configured to formulate the driving advice at least in part on the basis of information received from the other directors.

In some embodiments, the processor is configured to formulate the advice at least in part on the basis of information received from a traffic wizard.

In other embodiments, the processor is configured to formulate the advice at least in part on the basis of an assessment of driver condition.

Embodiments also include those in which the first director further includes a camera oriented toward the driver, and wherein the processor is configured to assess driver condition at least in part on the basis of an analysis of an image obtained from the camera.

Among the embodiments are those in which the processor is configured to advice the driver to maintain a selected gap between the road vehicle and a vehicle in front of the road vehicle, those in which the processor is configured to dynamically select the inter vehicle gap, and those in which the processor is configured to advice the driver of the first road vehicle to join a pack of directed vehicles.

In yet other embodiments, the processor is configured to advice the driver of the first vehicle to leave a first pack of directed vehicles and join a second pack of directed vehicles.

Other embodiments also include those in which a traffic wizard in communication with the director and with a plurality of additional directors, the traffic wizard is configured to coordinate movement of directed vehicles.

Certain other embodiments have a processor configured to guide the driver of the first vehicle to a designated available parking space.

Among further embodiments are those in which the processor is configured to communicate to the driver the existence of a pedestrian requesting a ride.

In another aspect, the invention features a method for managing flow of vehicular traffic. Such a method includes advising drivers of a plurality of directed vehicles to form a first pack of directed vehicles, the first pack having a lead vehicle and at least one trailing vehicle; advising each of the drivers of trailing vehicles in the first pack to maintain a selected inter-vehicle gap; receiving, from a driver of a first vehicle, information concerning an intended destination of the driver; and at least in part on the basis of the information, advising the driver of the first vehicle to join the first pack.

Some practices include those in which advising each of the drivers to maintain a selected inter-vehicle gap includes advising or enabling at least two drivers to maintain different inter-vehicle gaps.

Other practices include those in which advising each of the drivers to maintain a selected inter-vehicle gap includes providing appropriate information and/or communication to enable each of the drivers to maintain a selected inter-vehicle gap. Among these practices are those in which providing appropriate information and/or communication includes enabling at least two drivers to maintain different inter-vehicle gaps.

Other practices include those in which advising each of the drivers to maintain a selected inter-vehicle gap includes selecting the inter-vehicle gap on the basis of an assessment of abilities of the drivers.

Also included among the various practices of the invention are those in which advising each of the drivers of trailing vehicles to maintain a selected gap includes advising a trailing vehicle immediately behind the lead vehicle to maintain a gap that is greater than the gap that would have been advised if that trailing vehicle were immediately behind a pack vehicle other than the lead vehicle.

Yet other practices include those that include, for each of a plurality of packs of directed vehicles, receiving information representing a status of the pack; and at least in part on the basis of the information, instructing the directed vehicles of a pack to change their status.

Also included are practices in which wherein receiving information representing status of the pack includes receiving information concerning a status of the first pack on a first road, and a status of a second pack on a second road, the first and second roads crossing at an intersection, and wherein instructing the directed vehicles to change their status includes instructing vehicles of at least one of the first and second packs to adjust their speeds in manner that ensures that the first and second packs cross the intersection at different times.

Some practices feature changes based on time of day. For example, certain practices include including designating selected time intervals associated with a designated region, and prohibiting undirected vehicles from using roads within the designated region during the selected times.

Also included are practices that provide the driver of the first vehicle with guidance to parking space reserved for the first vehicle, and those that further include providing the driver of the first vehicle with information regarding a pedestrian requesting transportation.

Practices of the invention also include those that comply with 35 USC 101. It is these practices that are specifically intended to be covered by the attached claims.

Also included are computer-readable media that are non-transitory and tangible, and that include software for carrying out any of the foregoing methods. Only computer-readable media that comply with 35 USC 101 are intended to be covered by the claims.

These and other aspects of the invention will be apparent from a reading of the following detailed description and the accompanying figures.

### DESCRIPTION OF THE FIGURES

FIG. 1 shows a director mounted on a windshield;

FIG. 2 shows a pack of vehicles equipped with directors like that shown in FIG. 1;

FIG. 3 shows elements of the director shown in FIG. 1; and

FIG. 4 shows a traffic wizard supervising vehicles in packs such as that shown in FIG. 2.

FIG. 5 shows elements of another embodiment of a director;

FIG. 6 shows a close-up of the face of one embodiment of a director; and

FIG. 7 shows a close-up of the face of another embodiment of a director, with a servo-bar.

### DETAILED DESCRIPTION

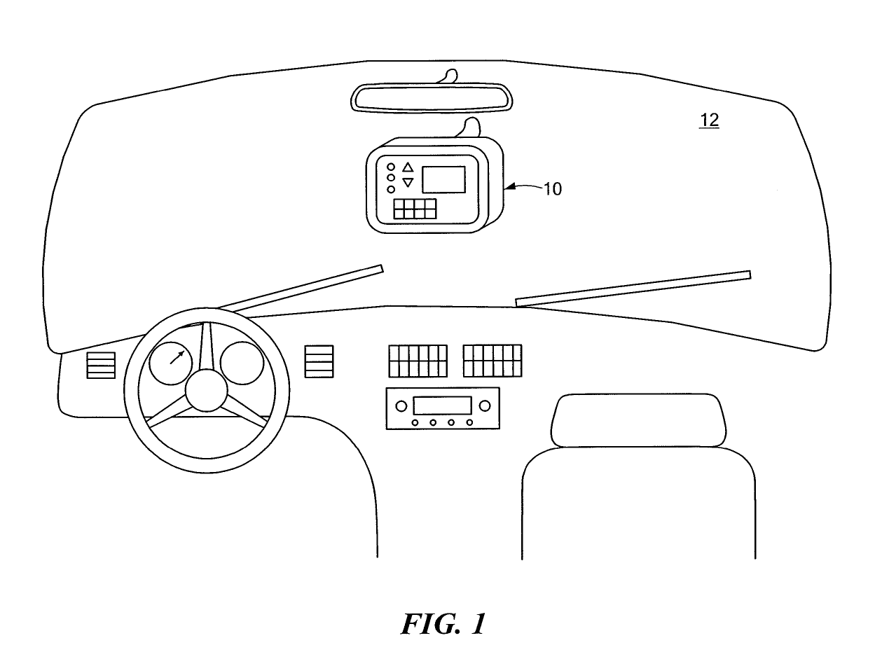

FIG. 1 shows a director 10 for use in a road vehicle. When the director 10 is used, the road vehicle is referred to as a “directed vehicle.” A road vehicle that either lacks a director 10 or in which the director 10 is not operating will be referred to herein as an “undirected vehicle.” As used herein, road vehicles include at least cars, trucks, buses, and similar vehicles.

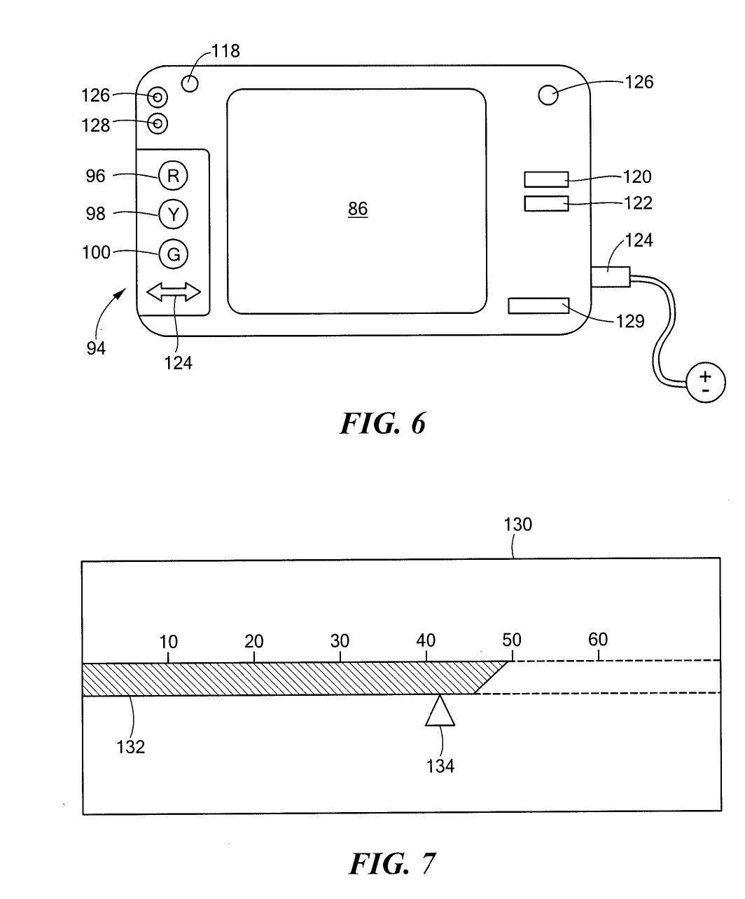

The director itself is a small device which is normally permanently installed in the road vehicle. A close-up of a front panel of a particular embodiment of a director 10 is shown in FIG. 6.

The director 10 is preferably mounted on the inside of a windshield 12, so that cameras within the director 10 can have a clear view forward and a clear view of the driver. Alternatively, parts of the director 10 can be separated from each other so that, for example, cameras looking forward can be mounted in one place, displays visible to the driver can be located in another place, and controls, computers and power supplies can be located in yet other places. The communication link between parts of the director 10 could be a wired link or a wireless link. Preferably, the director's visual displays 10 are oriented to place any displayed visual signals within the driver's peripheral field of view.

For power, the director 10 relies on either a portable power source, the vehicle's power supply or both. A power connection 124 provides a way for the director 10 to receive power from an external source. To enable the driver to turn it on and off, the director 10 also features a power switch 126.

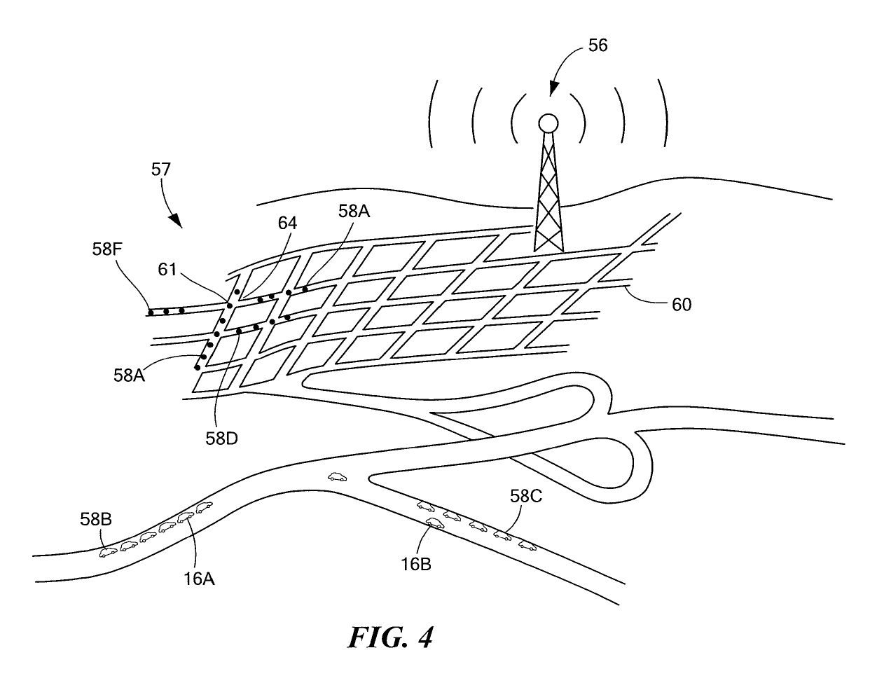

In operation, the director 10 receives information about a driver's intended destination in a manner similar to that commonly used in GPS systems. The director 10 receives such information either from the driver, from stored information selected by the driver, or from a remote information source, such as a traffic wizard 56, described in more detail below in connection with FIG. 4.

As the driver proceeds en route, the director 10 continuously offers the driver advice on how to efficiently reach his destination. Unlike a conventional GPS, which provides information about which roads to follow, the director 10 continuously provides detailed information and guidance that enables a driver to precisely maintain the position of his vehicle relative to other nearby vehicles while all such vehicles are caused to most efficiently navigate to their respective intended destinations in the face of rapidly changing traffic conditions.

A conventional GPS is, to some extent, a loner. To effectively plot a course, it requires little more than a positional signal, an internal database of maps and a receiver for receiving information about approximate traffic conditions.

In contrast, the director 10 is a social device that is in constant communication with the driver and with other directors 10 in its vicinity. As used herein, the “vicinity” refers to an area that is defined by the director 10 on the basis of the director's estimate of the extent of communication necessary for it to achieve its functions as described herein.

In many embodiments, as will be described below in connection with FIG. 4, the director 10 is also in communication with a centralized traffic wizard. In some embodiments, a director 10 can also function as a traffic wizard 56, either in an emergency or by design.

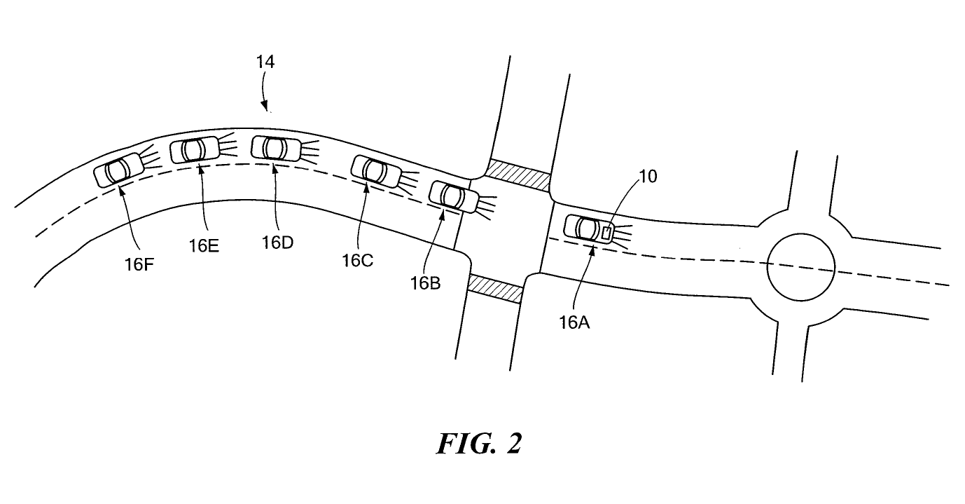

These directors 10 communicate and cooperate with each other, and with the centralized traffic wizard 56 when possible, to form temporary and constantly changing configurations of vehicles, called “packs,” as shown in FIG. 2. Such longer range communications would be handled by methods similar to those used by advanced cell phones. In addition, every director 10 would be in constant short-range wireless communications with all of the other directors 10 in its nearby area, the nearby area being defined by the extent to which the director 10 requires or finds useful communications with nearby traffic.

Each pack 14 consist of directed vehicles 16A-F that are all, for a period of time, traveling in generally the same direction. Directed vehicles can include personal automobiles and/or commercial vehicles, including trucks, busses, tractor trailers, trucks with semi-trailer, and trucks with full trailers.

A pack 14 can occupy a single lane, as shown in FIG. 2, or occupy multiple lanes. Except for a pack leader 16A, the vehicles 16B-F in a pack 14 tailgate other vehicles 16A-E in the pack 14. A pack 14 can vary in size from two vehicles to thousands of vehicles.

However, a common size for a pack 14 is 100 vehicles per lane. In some cases, a pack's size depends on its average speed. For example, the ratio of a pack's size to its speed can be maintained at a constant value, thus ensuring that the pack always take the same amount of time to cross a line across a road.

In some cases, any vehicle can be the pack leader 16A. However, there now exist enhanced vehicular cruise control systems that access more than simply a vehicle's throttle. One such enhanced vehicular cruise control system is the DISTRONIC PLUS™, manufactured by Mercedes. Such enhanced vehicular cruise control systems can, in addition to managing the throttle, also make use of the vehicle's brakes in order to maintain the selected distance to a vehicle ahead of it in the same lane, and can in fact actually bring the vehicle to a full stop. Enhanced cruise control systems that include automatic steering have also begun to appear. Vehicles equipped with an enhanced cruise control system having control over throttle, brakes and steering are particularly well adapted to operate synergistically with a director 10. Such vehicles will be referred to herein as “velocity control vehicles,” where the word “velocity” has its usual meaning as a vector quantity representing time derivative of position, and therefore including both a vector magnitude, commonly called “speed,” and a direction.

In some cases, the pack leader 16A is one such velocity controlled vehicle. In other cases, the pack leader 16A is a specially licensed driver.

As used herein, one vehicle 16C is said to safely tailgate another vehicle 16B if the gap between the vehicles 16B, 16C (the “inter-vehicle gap”) is much less than one would typically experience at similar speeds in conventional traffic flow, and considerably less than the inter-vehicle gap recommended in most driver's education courses. The directors 10 make it possible to safely reduce the inter-vehicle gap to distances that would be otherwise unsafe. For example, a common allowable separation between vehicles in a pack averages forty-five feet. Trucks, busses and other large vehicles would average greater separation distances.

There are many parameters, measurements and observations both present and dynamic or historical that would go into determining what the instantaneous appropriate inter-vehicle gap should be. That appropriate inter-vehicle gap may be changed dynamically, in response to criteria other than just vehicle speed. For example, in some embodiments the director 10 of each vehicle takes into account any combination of the previously observed characteristics of the particular driver involved, the vehicles, the roadways, the weather, the visibility, and/or characteristics of the vehicles and drivers ahead of and behind the vehicle. The director 10, possibly in conjunction with an external traffic wizard as described below, continuously analyzes many parameters and continuously makes adjustments to provide optimal and safe driving recommendations to the vehicle's operator.

For example, given a pack 14 of vehicles 16A-F, a second vehicle 16D may need to maintain a greater distance behind a first vehicle 16C because the driver of the first vehicle 16C has historically been prone to anomalous braking, or because the driver of the second vehicle 16D has historically been prone to have longer than normal reaction times. In other words, calculating the inter-vehicle distance between every pair of consecutive vehicles 16C-D is done independently and dynamically, taking into account all information known to be relevant. As a result, this inter-vehicle distance can change dynamically as the trip progresses.

Local traffic throughput is increased by increasing the average number of vehicles per hour per lane that a road can carry. This can be achieved by a combination of minimizing inter-vehicle spacing, causing packs to travel at higher average speeds, designating more roads as one way roads, and by minimizing circumstances that require vehicles to slow down or to stop and wait. Directors 10 achieve these goals by organizing directed vehicles into fast-moving packs 14 in which individual pack members practice controlled tailgating under director supervision.

For example, in some cases, a three second gap is recommended between one's vehicle and the vehicle one follows. That would imply that at 65 MPH one would have to maintain an inter-vehicle gap of 286 feet between vehicles. While providing such a distance may be good advice for an unassisted driver, a driver operating in a pack 14 coordinated by directors 10 can operate safely with very much smaller inter-vehicle gaps. Thus, the agglomeration of vehicles 16A-F into packs 14 through the cooperation of directors 10 in each vehicle, along with the cooperation of each of the vehicles in each pack 14, greatly increases road throughput, and thereby addresses some of the most vexing transportation problems, such as rush hour traffic, traffic jams, backups due to accidents, and the like.

Some traffic negotiation systems include a central system, such as a traffic wizard 56, as described in more detail in connection with FIG. 4. In such traffic negotiation systems, the central system knows the destination of each vehicle. Accordingly, the central system can locally and globally optimize routes, and can micro-manage what every vehicle does so as to move as much traffic, as quickly as possible using all of the capacity of all of the available roads. The traffic wizard discussed in connection with FIG. 4 can attempt to optimize the movements of all vehicles so as to achieve near optimal overall translation from beginning positions of all vehicles to end positions of all vehicles. The traffic wizard can, each day, compute apparent optimal solutions but can then discover at the end of the day how and why the results fell short of optimal. This provides a combination of human traffic experts and programmers with many days of trial experiences that can be used to discover solutions to essentially all of the circumstances that cause the traffic negotiation system to fall short of optimal performance. Thus, the overall traffic negotiation system is a self-optimizing system that, over time, improves its performance so as to attain what is optimal for the traffic load and roadway infrastructure. The same simulation capability can also be used to accurately predict the value of proposed changes to the roadway infrastructure and to accurately predict and/or simulate the effects of various construction projects.

As shown in FIG. 2, the gap between a pack leader 16A and its trailing vehicle 16B is somewhat larger than the remaining inter-vehicle gaps. This non-uniformity arises because given a column of undirected vehicles traveling at constant velocity and separated by a fixed inter-vehicle gap, when the driver of the pack leader 16A in the column jams on the brakes, the driver of the next vehicle 16B requires one unit of human reaction time before he too can jam on the brakes. This process repeats for each successive undirected vehicle 16C-F.

Because of these reaction time delays, each undirected vehicle 16B-F, while decelerating, inevitably continues to proceed a little bit faster than the vehicle 16A-E in front of it, simply because the vehicle in front of it has had a head start in braking. Consequently, as one proceeds back along the column, the gap between successive vehicles decreases until, if the column is long enough, it reaches zero. At this point, two undirected vehicles will have collided. In essence, such collisions occur because the information that tells a driver to decelerate travels back along the column at a speed of one vehicle per unit of human reaction time.

For vehicles 16A-F travelling in a pack 14, In a directed vehicle, the director 10 of the pack leader 16A eliminates this propagation delay by broadcasting a signal to each vehicle 16B-F in its pack 14, thus simultaneously warning all directors 10 of an impending deceleration. This makes it safer for an arbitrary number of vehicles 16B-F, all in one lane, to tailgate at high speed.

In fact, when directors 10 are used, the notion of a global speed limit effectively becomes obsolete. Different packs 14 will travel at different speeds. These speeds can adapt to circumstances such as, but not limited to, weather, lighting, condition and capability of both vehicle and driver, road conditions and topography.

In addition, the use of directors 10 in all vehicles eliminates the need for much road signage, such as left-turn signs, stop signs, and of course, speed limit signs. In effect, the director's instructions function as signs. However, unlike signs, the director's instructions are reprogrammable. Thus, the use of director 10 and the accompanying elimination of road signage allows the road system to be adaptively reprogrammed based on changing circumstances. For example, a wide street might be designated as one way inbound during a morning rush-hour, one way outbound during the evening rush hour, and two way in between. Or, if, for example, a low lying city had to be evacuated because of an on-coming hurricane or tsunami, a traffic wizard 56 could easily commandeer selected inbound roadways to create additional outbound roadways for evacuation.

More generally, a director 10 of any vehicle in a pack can detect anomalous behavior in the vehicle that it directs. Such anomalous behavior, in one example, is that caused by a driver of a directed vehicle 16C, which could be anywhere in a pack, who removes his foot from the accelerator in anticipation of braking. Under such circumstances, the director of that directed vehicle 16C immediately detects the resulting deceleration, even before the driver's foot has had time to completely leave the accelerator pedal. The director 10 then immediately and simultaneously sends a signal to every following vehicle 16D-F in the pack. This signal causes directors in those vehicles 16D-F to display a caution light as well as to utter the word “Caution.” If the driver of the directed vehicle 16C subsequently applies the brakes, the director 10 of that vehicle 16C detects this event and sends appropriate signals to the director of every following vehicle 16D-F in the pack. Those directors would then advise their respective drivers to slow down so as to maintain the pack's desired inter-vehicle gap.

As a result of the foregoing cooperation among directors, information proceeds backwards in a column of at a rate much greater than the rate at which similar information proceeds backwards in a column of undirected vehicles.

Because the second vehicle 16B in the pack faces somewhat more stringent requirements for maintaining the spacing to the pack leader 16A, the gap between the pack leader 16A and the second vehicle 16B should be somewhat larger than the inter-vehicle gaps between subsequent vehicles 16B-F.

All of the vehicles in a particular pack 14 will be travelling for some distance as a single group. Packs are frequently broken up and reformed as journeys continue. The length of a pack 14 could, in a metropolitan area, average about ½ mile. On an interstate, or other limited access road, or on a bridge or in a tunnel, the length of a pack could be very much longer. It is clear that the resulting roadway efficiency, measured in vehicles per lane per hour, could always be doubled and likely tripled. This would be extraordinarily important for expensive bridges or tunnels or urban limited access roads.

Each director 10 instructs its driver on how to best cooperate with the other directed vehicles in its pack 14.

As an example, a driver who wishes to change lanes for any reason can signal that intent by activating his turn signal. The driver's director 10 detects activation of the turn signal and transmits, to neighboring pack vehicles, information indicating that driver's intention. The directors in neighboring pack vehicles can then respond appropriately, for example by warning their respective drivers of the event and suggesting appropriate action.

There are many ways for the director 10 to detect such activation. In one case, the driver of a signaling vehicle puts on his turn indicators for a right turn. Other directors in nearby vehicles then notice the resulting turn signal. Those directors then inform the director in the signaling vehicle that its turn indicator is on and indicating a right turn. If one of the turn indicator lights has failed, other directors communicate that fact to the signaling vehicle's director. The directors 10 of neighboring vehicles detect the vehicle's flashing lights and infer the driver's intention. That intention is communicated to all other directors (in other vehicles) that might be in need of that information. In response, directors 10 in nearby various vehicles advise their respective drivers to slow down slightly in order to open a space to receive the signaling vehicle. Once a space opens up, the director 10 in the signaling vehicle advises the driver, using spoken instructions or a visual indicator, to change lanes.

Directors 10 of one or more nearby vehicles 16C-F, 16A may discover that a particular vehicle 16B has some problem that should be communicated to the driver of that vehicle 16B. For example, a door or trunk lid of the particular vehicle 16B may not be closed, one of its lamps may not be functional, anomalous smoke may be coming out of its exhaust, a trailer towed by that vehicle 16B may have defective brake lights, a turn flasher may be have been left on, the vehicle's headlights may not be on when required, etc. Upon receiving such information from one or more nearby vehicles 16C-F, 16A, the director 10 of the particular vehicle 16B can alert its corresponding driver and facilitate appropriate action if the driver decides it is necessary to correct the difficulty. For example, the director 10 of the particular vehicle may advise the driver on how to best come to a safe stop so that the driver can close the trunk lid.

In the case of a GPS, which instructs the driver on an optimal route, the driver is free to ignore the advice. The same is true in the case of a director 10. Thus, the director 10 does not control the vehicle any more than the GPS does; it merely provides advice that, if followed, will greatly assist the driver in quickly and safely reaching his intended destination.

On the other hand, the director 10 can be configured to communicate its advice with increasing levels of urgency. For example, a director 10 can include three differently-colored lights to distinguish between advice that is optional, advice that is legally mandated, and advice, that, if ignored, may impair safety. Alternatively, or in addition to the above visual cues, the director 10 may also provide audio cues to communicate different urgency levels.

For velocity-controlled vehicles, one can dispense altogether with human drivers in all but the first vehicle 16A of a pack 14. The result is a “pack train.” In such a pack train, directors other than that of the pack leader cause their respective velocity-controlled vehicles, referred to as “follower vehicles.” to do exactly what the pack leader does. Drivers of velocity-controlled follower vehicles can simply engage their transmissions and allow the enhanced cruise control, coupled to the director 10, to receive and follow instructions from the pack leader's director 10.

For example, the pack leader's director can transmit, to each follower vehicle's director, a time-stamped message indicative of its velocity at a particular point. The directors of follower vehicles can then cause their respective vehicles to have the same velocity upon reaching the same location.

A director 10 can be installed as an add-on to retrofit existing vehicles. Alternatively, directors 10 can be installed at the factory and integrated with selected vehicle subsystems. Initially, most directed vehicles will have acquired their directors 10 through an aftermarket purchase and installation. Eventually, all vehicles that are intended to be driven in traffic should come from the factory with a director 10 as standard equipment.

A number of advantages accrue to those vehicles having a factory-installed director 10. For example, a factory-installed director 10 can be more easily integrated with other vehicle subsystems. As one example, modern versions of cruise control include proximity sensors to detect and measure the distances to other vehicles and, if necessary to either automatically brake the vehicle or to automatically increase the braking force beyond what the driver has applied. Integration of a director 10 with such a subsystem frees the driver from the tedious task of maintaining a constant distance from a vehicle in front of him.

Integration of the director 10 with such vehicle subsystems improves the overall efficiency and safety of the traffic network in which the vehicle operates. As one example, if the director 10 can directly cause braking, or communicate directly with a cruise control system or an automatic braking system, the distance between vehicles in a pack 14 would no longer be limited by human reaction time. This would mean that inter-vehicle gaps could be made smaller and that more vehicles could use the road at any time, thus contributing to efficiency of the overall traffic network.

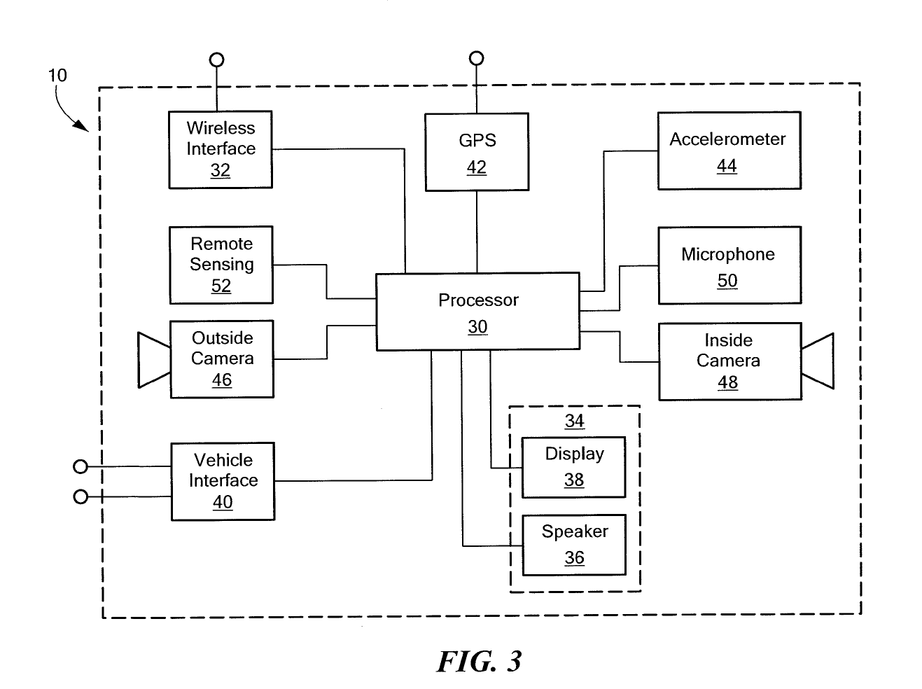

An exemplary director 10, as shown in FIG. 3, includes a processor 30 in communication with various elements. These elements include a wireless interface 32 for communicating with other directors 10, a driver interface 34 for communicating with the driver, using a speaker 36 or a visual displays 38, a vehicle interface 40 for communicating with various vehicle subsystems, and a GPS 42 for ascertaining the vehicle's location. To provide the director 10 with the ability to accurately navigate, by dead reckoning, even when the GPS signal is absent for a short period, such as when the vehicle is in a tunnel, or otherwise unable to lock into a GPS signal, the director 10 includes a method of dead reckoning navigation. 44. The processor 30 also implements machine vision systems that use cameras 46, 48 to identify features as described in detail below.

A director 10 as shown in FIG. 3 is configured to participate in a wireless network and/or cellular telephony network with high data rates. Each director 10 is in constant, low-latency direct digital communication with neighboring directed vehicles. Among the director's functions is that of advising a vehicle driver on how to best cooperate with nearby vehicles in order to optimize travel to the vehicle's destination according to a driver-selected objective function.

The director 10 communicates advise to the driver through the driver interface 34. The driver interface 34, shown in FIG. 3, can include a speaker 36, which is capable of being driven quite loud if necessary, and/or graphic symbols in a visual display 38 that are placed in the line of sight or within the range of the driver's peripheral vision.

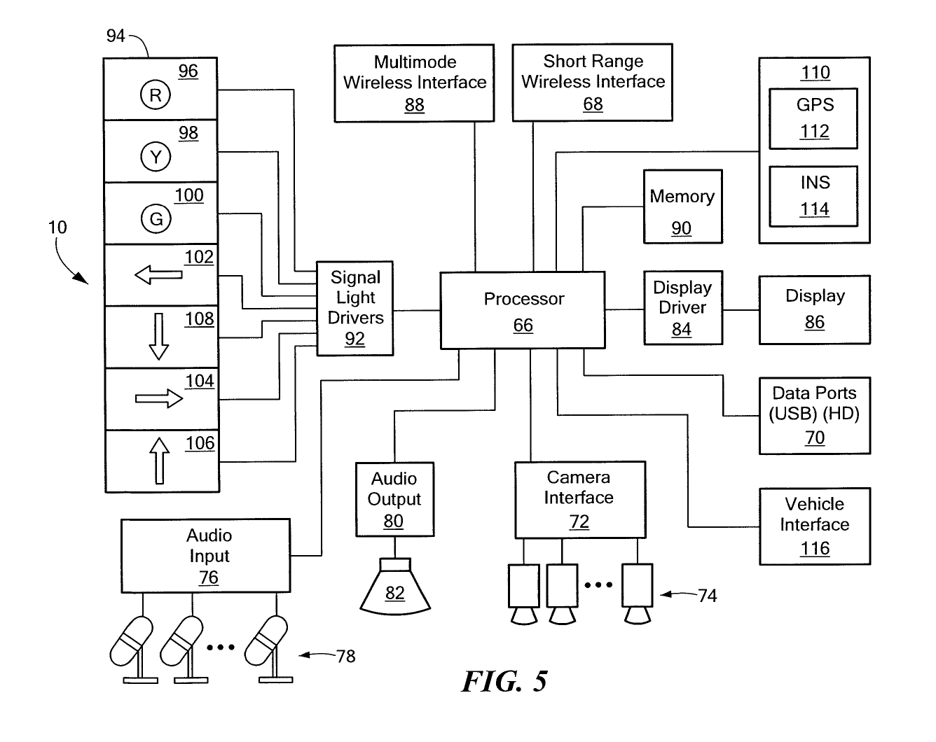

In an alternative embodiment, shown in FIG. 5, a director 10 includes a main processor 66 in communication with a memory subsystem 90. The memory subsystem 90 can include conventional memories such as ROM or RAM. The main processor 66 also accesses one or more ports 70, among which are one or more conventional or high speed USB ports 122, shown in FIG. 6, and one or more ports 120 for accommodating a memory card or flash drive, also shown in FIG. 6.

The director 10 shown in FIG. 5 also includes a camera interface 72 for receiving one or more cameras 74, audio inputs 76 for accommodating microphones 78 for receiving audio information from the surroundings, and an audio output 80 for driving a speaker 82 that provides spoken instructions to the driver.

For visual communication of instructions to the driver, the main processor 66 communicates with a display driver 84 that drives a main LCD display 86. In some embodiments, the display 86 is a dimmable display with an ambient light sensor 118, as shown in FIG. 6. In other embodiments, the display 86 is a high resolution display having a resolution in excess of 300 pixels per inch. The display 86 shows navigation information, such as maps, traffic information, alerts, and any other graphical or textual information the director 10 deems useful for the driver to know.

In some embodiments, the LCD display 86 is a touch-screen display that can also accept inputs from the driver. This display 86 can also be used to provide instructions to a positioning subsystem 110 that includes a global positioning system 112 and an inertial navigation system 114, implemented, for example, using linear and angular accelerometers, e.g. angular rate sensors.

To assist in achieving wireless communication with remote information sources, such as the traffic wizard described below in connection with FIG. 4, the director 10 also includes a multi mode wireless interface 88 in communication with the main processor 66. The multi mode wireless interface, in some embodiments, operates using the G3 and/or G4 cell phone standard. To assist in achieving wireless communication with other directors 10, the main processor 66 is also in data communication with a short range wireless interface 68. The short-range wireless interface, in some embodiments, has a range limited to approximately 1 kilometer.

To assist the director in communicating information to the driver visually, the main processor communicates with signal light drivers 92 that drive the various signal lights on a signal light panel 94. The individual signals in the signal light panel 94 include a red light 96 above a yellow light 98, and a green light 100 below the yellow light 98. The relative positions of the lights 96, 98, 100 are selected so that color blind drivers can read them correctly. The signal light panel 94 also includes a first arrow 102 that points to the left, a second arrow 104 that points to the right, a third arrow 106 that points up, and a fourth arrow 108 that points down. In some embodiments, these arrows 102, 104 can light up in different colors to communicate different types of information. In an alternative design, shown in FIG. 6, a panel 94 has a double-headed arrow 124.

In operation, the signal light drivers 92 drive the lights on the signal light panel 94. This includes turning individual signals on and off, as well as controlling the brightness of the signal, and/or flashing the signal according to selected rhythmic patterns. In some cases, the brightness of a signal can vary as a function of time. For example, a signal may be dim at first to avoid being obtrusive, but can become brighter as the director 10 attempts to attract the driver's attention. The delay in the driver's reaction to such a signal provides the director 10 with a basis for inferring inattention or impairment, which can then be used to alter the recommended speed or inter-vehicle distance associated with the driver.

The director 10 shown in FIG. 5 also includes a vehicle subsystem interface 116 to enable the director 10 to instruct vehicle subsystems, such as cruise control and automatic braking, as well as to receive data from vehicle subsystems. For example, by sensing real time data concerning gas consumption, the director 10 can provide the driver with instructions for improving gas mileage. Or, given the remaining distance to the destination and the amount of fuel left in the vehicle, the director 10 can advise the driver to search for fuel.

In one embodiment, a steady green light 100 instructs the driver the maintain his speed. A flashing green arrow 106, pointing upwards instructs the driver to speed up slightly to decrease the distance to the vehicle ahead. Conversely, a flashing yellow arrow 108 pointing downwards instructs the driver to slow down slightly to increase that same distance. A flashing yellow or green arrow 102, 104 pointing left or right instructs the driver to prepare to shift lanes to the left or right and to execute the lane shift. A steady yellow light 98 instructs the driver to use caution, while a flashing yellow light 98 instructs the driver to slow down. An extra bright red light 96 instructs the driver to aggressively decelerate.

In another embodiment, the speed control arrows 106, 108 can be replaced or supplemented by a servo bar, shown in FIG. 7. The servo bar 130 provides the driver with guidance on navigating through a one-dimensional velocity space in much the same way that a GPS 42 provides guidance through a two-dimensional position space.

As shown in FIG. 7, a servo bar 130 can take the form of an extendable line segment 132 having a length proportional to a target velocity, and a moving pointer 134 whose position relative to the extendable line segment 132 represents actual velocity. The servo bar 130 enables the driver to match vehicle speed with the target velocity by accelerating or decelerating so that the pointer 134 tracks the position of the extendable line segment 132. The extendable bar 132 can be made to change color at different speeds, ranging from green at low speeds, yellow at medium speeds, and red at high speeds.

Using the servo bar 130, the director 10 can guide the driver in slowing down and stopping a vehicle at a desired location in an unobtrusive but efficient way.

The director's audio output 80 communicates with the driver, regardless of ambient noise level. As is the case in many GPS units, the driver can instruct the audio output 80 to use a particular language selected from a list of languages. In general, once the traffic wizard or director 10 learns about a particular driver's desired language, it can make use of that fact in any other vehicle operated by that individual. This is also true of any other facts or observations that the traffic wizard or director 10 may have learned about the individual driver. To assist the director 10 in automatically adjusting audio output level, the director 10 provides one or more microphones 50 that detect ambient noise level and adjusts audio output levels as needed to overcome and be clearly heard above the ambient noise.

The director 10 is thus designed to easily be used by and completely intuitive to ordinary drivers without the necessity of special training in much the same way that an ordinary traffic signal controls traffic without requiring the driver to undergo special training

In some embodiments, the director 10 is equipped with an easily recognizable standard automatic pack light that indicates that the vehicle is operating as part of a pack 14. An externally visible pack light may be used to warn the drivers of undirected vehicles to avoid entering into the lane between two vehicles that are in a pack 14, regardless of the distance between those two vehicles.

Each director 10 can recognize whether or not nearby vehicles have active directors 10. Directed vehicles can thus communicate with each other and join to form a pack 14 if circumstances favor pack travel. In many embodiments, this is carried out in concert with a traffic wizard, as discussed below in connection with FIG. 4. But in other embodiments, it is carried out in the absence of any traffic wizard.

When a directed vehicle operates in traffic that includes undirected vehicles, the behavior of each director 10 depends on the mix of directed and undirected vehicles. Under these circumstances, it continues to be useful for a director 10 to be aware of nearby vehicles, regardless of whether they are directed or not. To achieve this, the director 10 can include a remote sensing system to collect information regarding the relative locations and velocities of nearby undirected vehicles. Exemplary remote sensing systems include visual, radar, LIDAR, and sonar systems.

In some embodiments, the remote sensing system can include a passive element, such as an outside camera 46 that constantly looks ahead of the vehicle. The outside camera 46 provides input for software that estimates the range to any vehicle visible to the forward-looking camera, whether in the same lane or in a different lane, and its relative speed. To assist the software in carrying out calculations for deriving distance from image size, it is useful to provide data for recognizing the type of vehicle that the outside camera 46 is looking at (i.e. by make, model, and year), so that the known physical dimensions of that vehicle could be used to accurately compute its range and relative velocity. In some embodiments, the outside camera 46 also detects that brake lights of one or more vehicles ahead have been turned on.

Additional cameras can also be provided, such as a rearward looking camera or a sideways-looking. Such additional cameras would carry out functions that are similar to or different than those carried out by a forward-looking camera. These additional cameras can be linked to a machine vision system for recognizing objects of interest. An interface between such a machine vision system and the director's audio interface can then provide spoken instructions to the driver to direct his gaze in a particular direction in which the machine vision system has identified an object that may be of interest.

In some embodiments, the director 10 makes judgments on driver performance and, based on its judgment of performance, tailors its advice to the driver. An inside camera 48, focused on the driver or on a regions at which the driver is expected to be, assists the director 10 in this task. The inside camera 48 can be a conventional video camera and/or an infrared camera. FIG. 6 shows a director 10 having an infrared port 126 through which infrared radiation can be received, and an infrared illuminator 128. Such a camera can be used for observing the driver, and for eye-tracking. The ability to perform eye-tracking enables the director 10 to infer what the driver is looking at and provides a basis for identifying driver inattention.

The inside camera 48 is configured to point toward the area in which a driver's face is expected to be. Such a camera includes software for carrying out certain tasks associated with assessing driver impairment. For example, the software can include instructions for recognizing or identifying the driver. Alternatively, the driver could be identified using a fingerprint, or password, or by receiving wirelessly transmitted data stored on a keychain fob or in a cell phone. In such cases, the inside camera 48 can optionally be used to verify such data and/or to assist in assessing driver impairment as described below. In yet another embodiment, the driver can be identified by cooperation between the camera 48 and either a fingerprint, password, or wirelessly transmitted data stored on a keychain fob or in a cell phone.

Once the driver is identified, the director 10 can retrieve his or her driving capability data and driving history at all times. The director 10 can both use that information, as described below, and update it as necessary. Meanwhile, the inside camera 48 monitors where the driver is looking, for example by looking at and calculating the driver's absolute eye orientation or in other cases, by using both the driver's head orientation and the driver's eye orientations to ascertain the driver's state of attention, for example by carrying out a visual analysis of the driver's face and/or absorbing visual clues indicative of driver impairment, and observing the driver's reaction times.

In addition to the use of a camera, the director 10 has other ways for determining the competency of the driver. For example, the director 10 can maintain pertinent driving history for the driver and constantly monitor the driver's behavior, including reaction times, to evaluate the driver's level of alertness and competency. The director 10 also monitors and rates statistical measures of every driver of its directed vehicle. The director 10 thus knows the average, historical and maximum reaction time latencies of every driver who drives its directed vehicle.

The director 10 compares a driver's normal parameters with instantaneous values of those parameters as measured in real time. It then takes action on the basis of an extent of a difference between the two. On the basis of its assessment of driver impairment, the director 10 alters the advice it offers the driver. This adjustment is dynamic, and occurs as the director's findings change with time.

In one example, a director 10 uses information about drivers by selecting which directed vehicles to include in a particular pack 14 on the basis of the characteristics of the current drivers of those vehicles and the conditions of those drivers. Thus, the director 10 rewards drivers who consistently drive well by including them in higher performance packs. Such packs may move at higher average speeds and with smaller inter-vehicle gaps. In contrast, the director 10 may place those drivers who exhibit decreased attentiveness or slower reaction times in a slower moving pack 14 with larger inter-vehicle gaps.

In some cases, the director 10 places drivers of different abilities in the same pack 14. It does so by adjusting other parameters of the pack 14. For example, the director 10 may increase inter-vehicle gaps in a pack 14 for those drivers that are known to have a slower reaction time.

Because it is more difficult to maintain a constant distance from a vehicle when the vehicle is further away, the director 10 can assist the driver by, for example, cuing the driver to speed up or slow down through the use of light signals or other means; e.g. by telling the driver that he is too far from or too close to the vehicle ahead of him.

In many embodiments, the directors 10 are in communication not only with each other but also with a remote traffic wizard 56, as shown in FIG. 4. A traffic wizard 56 maintains information about all vehicles and packs 58A-D in a large area, such as a metropolitan area 57. Each wizard 56 is an informational, computational, and communications center that is competent over a particular area 57. Just as directors 10 assist directed vehicles 16 in a pack 14 in cooperating with each other, a traffic wizard 56 may instruct directors 10 in different vehicles or packs 58A-D on how to cooperate with each other or on other matters. For example, because the traffic wizard 56 maintains real-time information about pack locations and destinations, it can carry out dynamic route selection and dynamic rerouting, all based on the instantaneous and predicted traffic, on knowledge about existing or expected traffic conditions, construction, weather conditions, accidents, or any other matter that might affect traffic flow patterns. In addition, since the wizard 56 already provides the foregoing information to the director 10, the director 10 can also, at the driver's request, display any of this information.

The traffic wizard 56 receives information from directed vehicles 16A-B. Such information includes, for example, position, velocity, acceleration, intention, and the like. Similarly, each vehicle director 10 may receive similar information concerning other nearby vehicles, either from the vehicles or from the traffic wizard 56.

In operation, the director 10 knows the driver's plan and learns of any changes in that plan as these changes occur. If the vehicle is in range of a traffic wizard 56, the director 10 forwards its destination information and any change in its plans to the wizard 56. In some cases, the directors 10 and the traffic wizard 56 operate in a manner that protects the privacy of all travelers.

Once vehicles 16A-B are underway, the traffic wizard 56 will, as soon as practical or useful, organize vehicles into packs 58A-D of vehicles that are currently proceeding in the same general direction. In some cases, for convenience, packs are of a standard length and/or gaps between packs are standardized. From time to time the director 10, under instructions from the traffic wizard 56, advises a driver of a directed vehicle 16 to leave one pack 58B and join another pack 58C. At the beginning or near the end of a trip it will be common for vehicles to not be in any pack at all.

A directed vehicle 16A typically leaves a pack 58B by shifting into a lane to the right. Conversely, a directed vehicle 16B typically joins a pack 58C by proceeding in the lane to the right of a pack, and, in response to advice from the director 10, speeding up or slowing down. In preparation for accepting a new vehicle into the pack 14, directors 10 mounted in some of the other directed vehicles from the pack 58C would have been signaled to slow down slightly so as to open up a space for the vehicle 16B joining the pack 58C. Ultimately, the vehicle 16B merges into an opening that the directors 10 within the pack 58C have conspired to create on behalf of the merging vehicle 16B.

In one example, a traffic wizard 56 assists packs 58A, 58D in negotiating cross streets at full speed without having to stop. This is achieved by controlling separation between packs (“inter-pack gaps”) so that coordinated packs 58A, 58E, 58F on intersecting roads 60, 61 arrive at staggered times. As a result, a pack 58A can cross the intersection 64 during a gap between consecutive packs 58E, 58F on a cross street. Because of this, none of the packs 58E, 58F, 58A has to slow down significantly. By making minor adjustments to the speeds of packs 58A-E under its influence, the traffic wizard 56 generally avoids having a pack slow down significantly or come to a complete stop. On the other hand, the traffic wizard 56 sends instructions to dynamically change the speed of the pack 58A-E from time to time. This enhances fuel efficiency be eliminating a great deal of stop and go traffic.

In many implementations, there are designated periods during which all traffic is restricted to directed vehicles. Such designated periods would typically be morning and evening rush hour, but can include times surrounding special events that are known to generate considerable traffic. Eventually, it is expected that all vehicles will have directors.

During the above-mentioned designated periods, all normal traffic control (stop signs, signals, speed limits, “no turn” rules, etc.) would be officially suspended. Instead, the traffic wizard 56, through its directors 10, would provide instructions for all directed vehicles. In addition, selected streets that are usually two-way streets would be changed to one-way streets. During such designated periods, pedestrian and bicycle access are also controlled, as is now the case on limited-access roads, such as interstate highways.

The exclusive use of directors 10 and traffic wizards 56 during designated periods would substantially increase the average speed of every vehicle traveling into, out of, or within a metropolitan area.

In some embodiments, the traffic wizard 56 provides other services that do not involve coordination of packs, and that are of value to an individual vehicle.

For example, in one such service, a driver, before starting a trip, contacts the traffic wizard 56 by phone, computer or through the director 10 and obtains a predicted driving time to a particular destination given the starting point and the starting time. The driver and the traffic wizard 56 optionally exchange information in an effort to negotiate the best combination of starting time and travel time. During such negotiations, the driver can propose an arrival time and be provided with a corresponding estimated departure time. A dialog can then occur that results in an agreement on a solution for the driver.

In another such service, the traffic wizard 56 accepts a reservation for a particular departure time and commits to routing the driver to his destination within a specified interval. In such cases, the traffic wizard 56 takes such reservations into account in planning traffic flow and in planning the trip for that individual. At rush hour, everyone will be able to get an optimized trip by making advanced reservations with the traffic wizard 56. This enables the traffic wizard 56 to know in advance projected departure times or expected arrival times. The traffic wizard 56 can suggest earlier or later departure or arrival times in order to minimize driving times.

There are many other services that the traffic wizard 56 might perform. If parking is required at the destination, the traffic wizard can arrange for parking and direct the vehicle to the parking location.

Specifically, a wizard 56 can receive, from the driver, by way of the director 10, the driver's parking preferences, including preferred type of parking location, such as on-street parking, outdoor lot parking, or garage parking, distance from destination, or cost. Based on these preferences, its knowledge of the vehicle's expected arrival time, and the availability of parking, the wizard reserves a space for the vehicle and directs the vehicle to that space.

Having guided the vehicle to a parking space, the wizard 56 can also handle financial details associated with parking, such as assessing a parking fee based on time spent parking, and billing the driver on a periodic basis.

By managing the parking of vehicles on a regional scale, the traffic negotiation system described herein also eliminates the need for parking meters or signs announcing parking regulations. In effect, the regulatory functions of signage and the revenue collection of parking meters are both carried out by the traffic negotiation system.

The use of a traffic wizard to regulate parking on a regional scale also enables parking regulations to easily be changed dynamically. For example, it becomes a simple matter to restrict on-street parking to periods outside rush hour, thus avoiding the resulting narrowing of roads.

Emergency vehicles can be given priority as appropriate, where the traffic ahead of the emergency vehicle is shunted aside ahead of the emergency vehicle's intended path. It should always be possible for any emergency vehicle to proceed directly to its destination at an average speed that is never slower than 60 MPH. No external siren would be necessary (except for warning pedestrians).

A traffic negotiation system along the lines of the foregoing can be implemented at minimal cost, particularly when that cost is compared to the benefits. For example, such a traffic negotiation would provide many environmental benefits, such as reducing fuel consumption, and would avoid the waste of millions of man-hours per day in very large metropolitan areas.

Finally, to the extent a traffic wizard 56 can be used all the time, major cities will be able to remove almost all signage (such as speed limit signs, traffic signals, stop signs, and the like). Such signs or signals would no longer be useful because information normally conveyed by the signs or signals can, instead, be conveyed by the director, and only when appropriate. For example, instead of a sign displaying “NO TRUCKS IN LEFT LANE” the director in a truck could convey that information to the driver of a truck when appropriate. But the director for a passenger car would not bother the driver of a car with that information. This selective transmission of information avoids distracting drivers unnecessarily.

The traffic negotiation described herein effectively adds road capacity without the need to actually improve or add to existing infrastructure, for example by adding lanes, flyovers, multilevel intersections, and similar structures.

In general, it is preferable to separate pedestrians and from fast moving vehicle traffic. In areas where it is impractical to do so, a cell phone carried by the pedestrian and which has a GPS 42 or other locating device executes an application that assists the pedestrian in crossing streets. Such an application communicates with the traffic wizard 56 and determines when the next pack will reach the pedestrian's crossing point. From this information, the pedestrian could determine when it is safe to cross a street at any location, without the need to locate a pedestrian crossing. Otherwise, conventional signals coordinated with the traffic wizard could be used to control pedestrian traffic.

In some practices, cameras monitoring pedestrian crossing zones can detect and track various obstacles to traffic, such as a person, animal, or random vehicle (such as bicycles or skateboards). Information about any such anomalies is then directed to the traffic wizard 56. The traffic wizard 56 would then determine if any pack is on a collision course with the obstacle and if so, alter the state of that pack to avoid such a collision.

In another embodiment, a traffic negotiation system having a traffic wizard 56 that communicates with directors 10 can implement a novel mode of public transportation that can supplement or replace conventional modes, such as buses and subways. In this embodiment, a pedestrian group, which can have one or more pedestrians, communicates its intended destination to the traffic wizard 56. Such communication can take place by cell phone, or by a suitably configured cell phone application.

In response, the traffic wizard 56 identifies a directed vehicle 16A with appropriate capacity and a suitable destination, and advises that directed vehicle 16A that one or more passengers need a ride. Under normal circumstances a directed vehicle 16A will stop to pick up the pedestrians within a few minutes. The vehicle can be a car or van depending on what is available and what capacity is needed. If a pedestrian indicates that he is carrying considerable luggage, he may request, for example, a vehicle with trunk space.

The directed vehicle 16A may take the pedestrian group to its intended destination, for example if the destination is along the route being followed by that directed vehicle 16A. Alternatively, the directed vehicle 16A will take the passenger group part way to their intended destination, to either complete the journey on foot or to be picked up by another directed vehicle 16B traveling closer to the intended destination.

In one embodiment of such a system, there are convenient exchange points where directed vehicles 16A can safely drop off or pick up pedestrian groups without obstructing traffic. Otherwise, various curbside locations can be designated as pickup or drop-off zones.

Participation by directed vehicles in such a system is optional. However, in an effort to promote widespread participation, it is useful to provide an incentive. One incentive is money. In one example of such a system, each pedestrian is charged a fixed amount per pickup, and a variable amount based on distance travelled. The charge can be posted to a charge card number stored within the cell phone, or to the cell phone account itself. The details of arranging payment would be part of the application setup. On the receiving side, the driver's bank account or credit card account is credited by a corresponding amount.

To alleviate concerns about security, the wizard 56 stores information identifying the driver and all passengers. In directors 10 that have an inside camera 48, this information can be verified by using the inside camera 48 in conjunction with facial recognition software to inspect the passengers and by establishing communication between the director 10 and the cell phone used to request the ride. Preferably, no ride is provided unless the passengers are first identified. To maintain privacy, no identification information will be given to the driver. The resulting system is thus safer than taking a bus, for both the pedestrians and the driver.

In some case, after a particular trip, a pedestrian and/or driver can communicate an experience rating to the wizard 56. If the experience rating is generally positive, the wizard 56 can make an effort to match the driver and pedestrian again the next time one or the other calls for a ride. Conversely, if the experience rating is negative, the wizard will avoid matching the driver to the pedestrian the next time one of them calls for a ride.

The system is activated for a given directed vehicle 16A if and when the driver indicates a willingness to pick up pedestrian groups. Preferably, no pedestrian group is picked up until the traffic wizard 56 is reasonably assured that the pedestrian group can be taken all the way to its destination, even if the journey requires multiple transfers. The traffic negotiation system chooses an optimum trip for the pedestrian group that minimizes the number of transfers and/or estimated travel time. In addition, the traffic negotiation system restricts pickups and drop-offs so that no passenger will have to endure more than some predetermined number of such events in any given journey.

When a pedestrian uses an application to schedule a trip, the wizard 56 estimates the total trip time, number of expected transfers, and cost. On the basis of this information, the pedestrian has the option of finding other means of transportation if the proposed arrangements are unsatisfactory.

In some embodiments, if the pedestrian agrees, the wizard 56 mixes public transportation with private vehicles in some optimal way. For example, a particularly long ride could start with a pedestrian receiving a ride from a directed vehicle to a first train station, a train ride to a second train station, followed by a ride in another directed vehicle from the second train station to the final destination.

A system of directors 10 controlled by a wizard 56 can be used wherever traffic requires guiding for optimization. This is not restricted to automotive traffic. For example, in an amusement park having multiple attractions spread over a large area, each patron can be provided with a director 10 linked to a wizard 56 that recognizes the throughput of each attraction in the park. The patron can then enter, into the director 10, a list of desired attractions. The director 10 can then plot an optimal route to visit all or as many attractions as possible, taking into account expected wait times at each attraction, and walking times between attractions.

A similar system can be implemented to guide tourists through a city or national park in much the same way that the Freedom Trail assists tourists in finding various attractions in downtown Boston.

Having described the invention, and a preferred embodiment thereof, what we claim as new, and secured by letters patent is:

1. A system for managing traffic by providing information to a driver of a first road vehicle, said system comprising:
a first director adapted for mounting in said first road vehicle, said first director including:
a user interface for communicating said advice to said driver and for receiving information from said driver, said information being indicative of driver intent;
a communication system for establishing communication with other directors in other road vehicles;
a positioning system for establishing a location of said first director; and
a processor configured to formulate said driving advice at least in part on the basis of information received from said other directors.

2. The system of claim 1, wherein said processor is configured to formulate said advice at least in part on the basis of information received from a traffic wizard.

3. The system of claim 1, wherein said processor is configured to formulate said advice at least in part on the basis of an assessment of driver condition.

4. The system of claim 1, wherein said first director further comprises a camera oriented toward the driver, and wherein said processor is configured to assess driver condition at least in part on the basis of an analysis of an image obtained from said camera.

5. The system of claim 1, wherein said processor is configured to advice said driver to maintain a selected gap between said road vehicle and a vehicle in front of said road vehicle.

6. The system of claim 1, wherein said processor is configured to dynamically select said inter vehicle gap.

7. The system of claim 1, wherein said processor is configured to advice said driver of said first road vehicle to join a pack of directed vehicles.

8. The system of claim 1, wherein said processor is configured to advice said driver of said first vehicle to leave a first pack of directed vehicles and join a second pack of directed vehicles.

9. The system of claim 1, further comprising a traffic wizard in communication with said director and with a plurality of additional directors, said traffic wizard being configured to coordinate movement of directed vehicles.

10. The system of claim 1, wherein said processor is configured to guide said driver of said first vehicle to a designated parking space.

11. The system of claim 1, wherein said processor is configured to communicate to said driver the existence of a pedestrian requiring a ride.

12. A method for managing flow of vehicular traffic, said method comprising:
advising drivers of a plurality of directed vehicles to form a first pack of directed vehicles, said first pack having a lead vehicle and at least one trailing vehicle;
advising each of the drivers of trailing vehicles in said first pack to maintain a selected inter-vehicle gap;
receiving, from a driver of a first vehicle, information concerning an intended destination of said driver; and
at least in part on the basis of said information, advising said driver of said first vehicle to join said first pack.

13. The method of claim 12, wherein advising each of the drivers to maintain a selected inter-vehicle gap comprises advising at least two drivers to maintain different inter-vehicle gaps.

14. The method of claim 12, wherein advising each of the drivers to maintain a selected inter-vehicle gap comprises selecting said inter-vehicle gap on the basis of an assessment of abilities of said drivers.

15. The method of claim 12, wherein advising each of the drivers of trailing vehicles to maintain a selected gap comprises advising a trailing vehicle immediately behind said lead vehicle to maintain a gap that is greater than the gap that would have been advised if that trailing vehicle were immediately behind a pack vehicle other than said lead vehicle.

16. The method of claim 12, further comprising:
for each of a plurality of packs of directed vehicles, receiving information representing a status of said pack;
at least in part on the basis of said information, instructing said directed vehicles of a pack to change their status.

17. The method of claim 16,
wherein receiving information representing status of said pack comprises receiving information concerning a status of said first pack on a first road, and a status of a second pack on a second road, said first and second roads crossing at an intersection, and
wherein instructing said directed vehicles to change their status comprises instructing vehicles of at least one of said first and second packs to adjust their speeds in manner that ensures that said first and second packs cross said intersection at different times.

18. The method of claim 12, further comprising designating selected time intervals associated with a designated region, and prohibiting undirected vehicles from using roads within said designated region during said selected times.

19. The method of claim 12, further comprising providing said driver of said first vehicle with guidance to an available parking space reserved for said first vehicle.

20. The method of claim 12, further comprising providing said driver of said first vehicle with information regarding a pedestrian requesting transportation.
